(19) United States
(12) Patent Application Publication
(10) Pub. No.: US 2009/0064229 A1
(43) Pub. Date: Mar. 5, 2009

(54) Recommendation from stochastic analysis

(75) Inventor: Ronald A. Morris, San Francisco, CA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/897,498

(22) Filed: Aug. 30, 2007

(51) Int. Cl. G06F 3/00

(52) U.S. Cl. 725/46

(57) ABSTRACT

Recommendations from stochastic analysis is described. In embodiment(s), a media content distributor can receive a request for movie recommendations from a viewer via a television client device. The content distributor can then provide various movie selection choices where each choice includes two movies having disparate identifying criteria. The identifying criteria can include any combination of a category of a movie, an attribute of the movie, or an aspect of the movie. The content distributor can receive viewer selections of one movie from each of the movie selection choices and then generate the movie recommendations for the viewer. The movie recommendation can be generated by stochastic analysis of the identifying criteria associated with the viewer selected movies from each of the movie selection choices.

### BACKGROUND

Viewers have an ever-increasing selection of television programming and on-demand choices from which to choose from, and may want to locate programming and movie choices that are of interest to them. In addition to the scheduled television program broadcasts, viewing options also include the on-demand choices which enable a viewer to search for and request media content (e.g., movies) for viewing when convenient rather than at a scheduled broadcast time. Typically, a viewer can initiate a search for a list of television programming choices and on-demand viewing choices in a program guide (also commonly referred to as an electronic program guide or “EPG”).

A typical program or movie description shown in a program guide merely provides a short plot description, rating information, a list of some cast members, and/or other information associated with the media content. The other associated information can include metadata that is used to describe and categorize the media content. The simple program and movie descriptions, however, rarely provide enough information for a viewer to decide whether a program or movie will be of interest to them.

The metadata associated with a program or movie can be obtained from any number of providers and compiled to include information that describes and/or characterizes the media content. For example, the metadata associated with a movie can include the title, a plot description, actor information, artistic information, music compilations, and other descriptive information about the movie. However, the conventional metadata associated with movies is not very informative. For example, the genre descriptions “Drama”, “Comedy”, or “Romance” often do not fully describe or capture the qualities of any one particular movie. A movie that is characterized as a “Drama” may also include many comedic and/or romantic situations, thus making it difficult to recommend to viewers when requested. A recommendation system may not recommend the “Drama” movie as a comedy or romance recommendation when requested, even though the movie may likely to of interest to a viewer.

### SUMMARY

This summary is provided to introduce simplified concepts of recommendations from stochastic analysis. The simplified concepts are further described below in the Detailed Description. This summary is not intended to identify essential features of the claimed subject matter, nor is it intended for use in determining the scope of the claimed subject matter.

In embodiment(s) of recommendations from stochastic analysis, a media content distributor can receive a request for movie recommendations from a viewer via a television client device. The content distributor can then provide various movie selection choices where each choice includes two movies having disparate identifying criteria. The identifying criteria can include any combination of a category of a movie, an attribute of the movie, or an aspect of the movie. The content distributor can receive viewer selections of one movie from each of the movie selection choices and then generate the movie recommendations for the viewer. The movie recommendation can be generated by stochastic analysis of the identifying criteria associated with the viewer selected movies from each of the movie selection choices.

In other embodiment(s) of recommendations from stochastic analysis, the media content distributor can compile descriptions of the identifying criteria associated with the movies. The descriptions can include any type of description of a movie category, attribute, or other aspect of a movie. The content distributor can then generate qualitative metadata of the movies from the compiled descriptions. The content distributor can also receive viewer selections of one movie from each of the movie selection choices where each choice includes two of the movies having disparate qualitative metadata. The content distributor can then apply stochastic analysis on the qualitative metadata associated with the viewer selected movies to generate the movie recommendations.

### BRIEF DESCRIPTION OF THE DRAWINGS

Recommendations from stochastic analysis is described with reference to the following drawings. The same numbers are used throughout the drawings to reference like features and components:

FIG. 1 illustrates an example system in which embodiments of recommendations from stochastic analysis can be implemented.

FIG. 2 illustrates example method(s) for recommendations from stochastic analysis in accordance with one or more embodiments.

FIG. 3 illustrates example method(s) for recommendations from stochastic analysis in accordance with one or more embodiments.

FIG. 4 illustrates various components of an example device which can implement embodiments of recommendations from stochastic analysis.

FIG. 5 illustrates various devices and components in an example entertainment and information system in which embodiments of recommendations from stochastic analysis can be implemented.

### DETAILED DESCRIPTION

Recommendations from stochastic analysis is described and embodiments provide that a viewer can request media content recommendations, such as for movies, and receive movie recommendations that are likely to be of interest to the viewer. In an embodiment, the viewer is presented several movie selection choices where each choice includes two movies having disparate identifying criteria, such as different categories, attributes, aspects, and/or other information associated with the movies. From just a few viewer selections of movie choices, the movie recommendations that are likely to be of interest to the viewer can be determined by stochastic analysis of the identifying criteria that is associated with the viewer selected movies from the different movie selection choices.

While features and concepts of the described systems and methods for recommendations from stochastic analysis can be implemented in any number of different environments, systems, and/or various configurations, embodiments of recommendations from stochastic analysis are described in the context of the following example systems and environments.

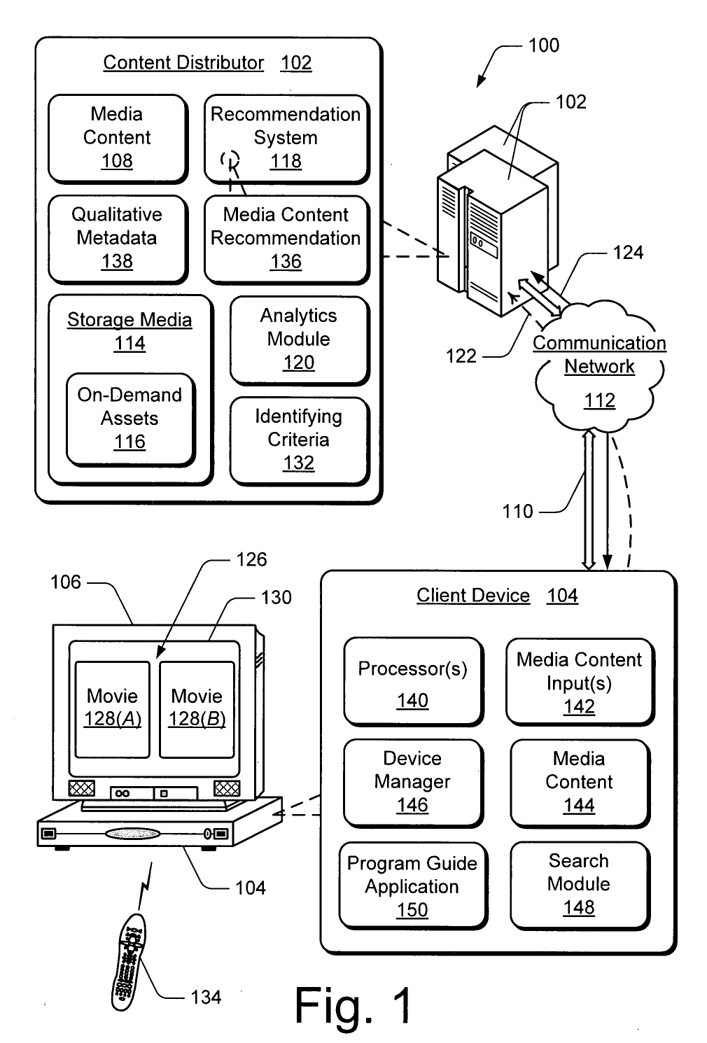

FIG. 1 illustrates an example system 100 in which various embodiments of recommendations from stochastic analysis can be implemented. In this example, system 100 includes content distributor(s) 102, a television client device 104, and a display device 106. The client device 104 and display device 106 together are just one example of a television client system that renders audio, video, and/or image data. The display device 106 can be implemented as any type of television, LCD, or similar display system.

A content distributor 102 can distribute media content 108 to any number of television client devices as an IPTV multicast via an IP-based network 110 and/or a communication network 112. As described throughout, “media content” can include television programs (or programming) which may be any form of programs, commercials, music, movies, and video-on-demand media content. Other media content can include interactive games, network-based applications, and any other audio, video, and/or image content (e.g., to include program guide application data, user interface data, search results and/or media content recommendation data, and the like).

The IP-based network 110 can be implemented as part of the communication network 112 that facilitates media content distribution and data communication between the content distributor(s) 102 and any number of client devices, such as client device 104. The communication network 112 can be implemented as part of a media content distribution system using any type of network topology and/or communication protocol, and can be represented or otherwise implemented as a combination of two or more networks.

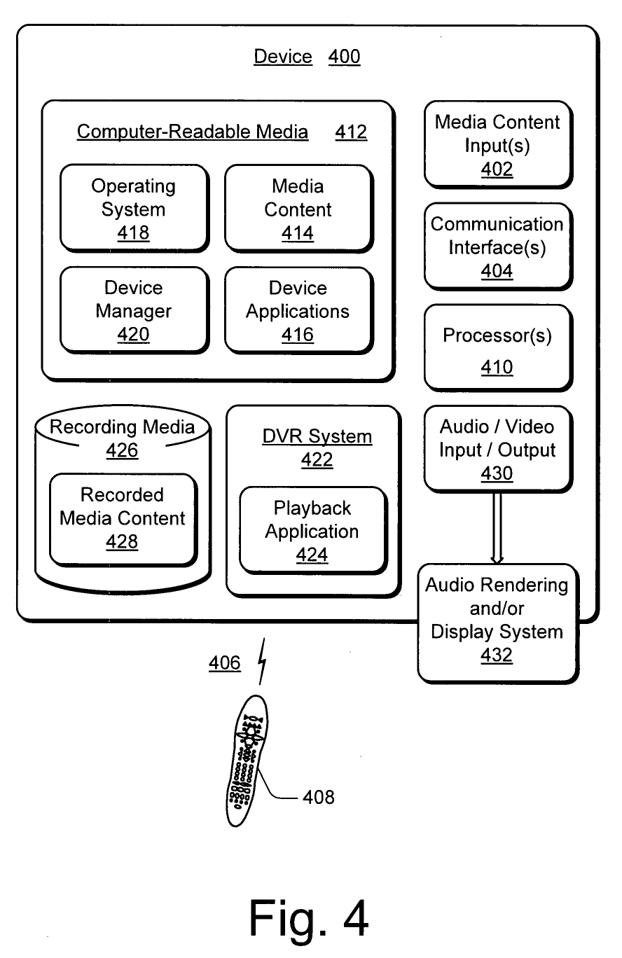

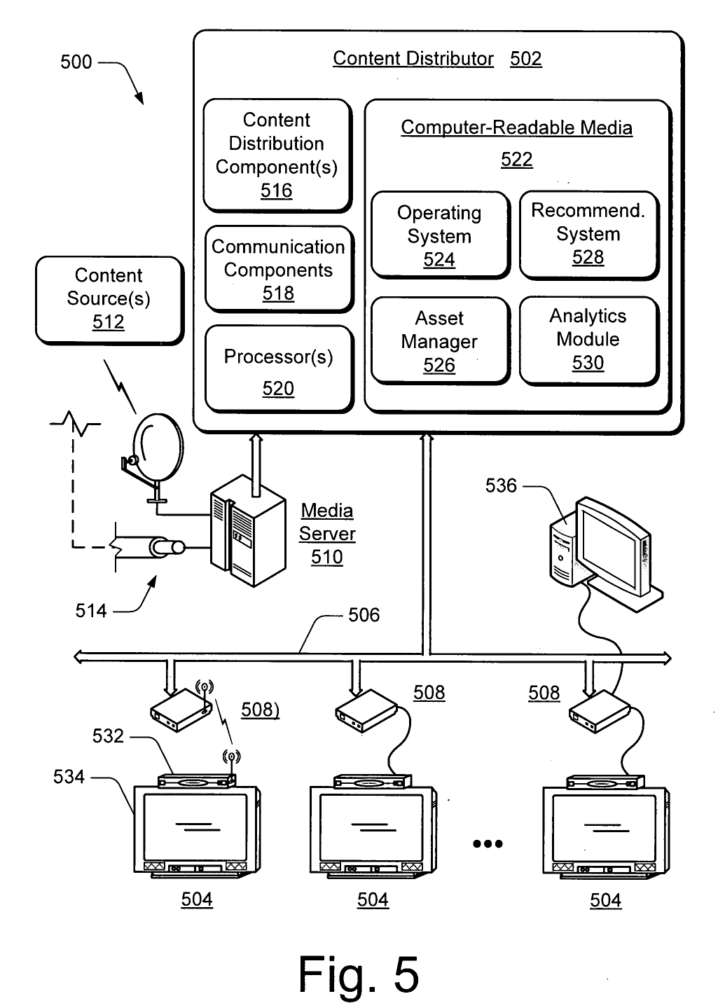

The content distributor 102 can include various components to implement embodiments of recommendations from stochastic analysis. In this example system 100, content distributor 102 includes storage media 114 to store or maintain the media content 108 and/or on-demand assets 116 that can be requested by various television client devices. The content distributor 102 can also include an asset manager to manage the assets maintained by the content distributor, such as the media content 108 and/or the on-demand assets 116. In addition, a content distributor 102 can be implemented with any number and combination of differing components as further described with reference to the example device shown in FIG. 4 and/or the example content distributor shown in FIG. 5.

The content distributor 102 also includes a recommendation system 118 and an analytics module 120 to implement embodiments of recommendations from stochastic analysis. The recommendation system 118 can be implemented to receive a request 122 for movie recommendations from a client device, such as from television client device 104. A client device 104 may also request other media content recommendations, such as for television programs, music, and the like.

The content distributor 102 can receive requests from client devices, such as request 122 for a movie recommendation, via a two-way data communication link 124 of the communication network 112. It is contemplated that any one or more of the arrowed communication networks and/or links 110 and 124, along with communication network 112, facilitate two-way data communication, such as from client device 104 to a content distributor 102 and vice-versa.

In response to receiving a request for a move recommendation, the recommendation system 118 for content distributor 102 can also be implemented to provide several movie selection choices to a viewer via the television client device 104. A movie selection choice 126 of two different movies 128(A) and 128(B) can be received by the television client device 104 and displayed as a user interface 130 on the display device 106. In this example, the two movies 128(A) and 128(B) can be displayed as movie posters that include images from a movie and photos of the main actors, as well as text, graphics, and/or other images associated with a particular movie.

In an embodiment, a movie selection choice 126 includes the two movies 128(A) and 128(B) that have disparate identifying criteria 132. As described throughout, the “identifying criteria” of media content, such as a movie, can include a category of a movie, an attribute of the movie, an aspect of the movie, and/or any other associated information. A category (also commonly referred to as a “genre”) of a movie can include any one of action, adventure, comedy, documentary, crime, drama, history, horror, musical, science fiction, war, western, mystery, and romance. An attribute (also commonly referred to as a “descriptor”) of a movie can include any one of sports, medical, family, military, violence, sex, suspense, religious, police, thriller, teen, detective, law, adult, love, tragedy, terror, new movie, kids, and the like. Other aspects of a movie can include any information relating to the plot, ending, theme (e.g., genre), musical score, actors and actresses (e.g., A-list actors, B-list actors, “new to the screen”), cinematography, dialogue, etc.

As stated, the two different movies 128(A) and 128(B) have disparate identifying criteria 132 such that a viewer can select whichever of the two different movies 128(A) and 128(B) that appeals to the viewer. For example, a sequence of movie selection choices may first include a choice between an old movie and a new movie, then a choice between an adult movie or a kids movie. Then a next movie selection choice may be a choice between a horror movie or a western. After only a few viewer selections, the viewer has indicated a preference for new movies that are adult in nature having a western or other related theme. A viewer can interact with the television client device 104 and initiate selections of the movie choices from the user interface 130 with user inputs on an input device 134, such as a television remote control.

The recommendation system 118 at content distributor 102 can receive the viewer selections of one movie from each of the movie selection choices via the two-way data communication link 124 of the communication network 112. The recommendation system 118 can then initiate the analytics module 120 to generate one or more movie recommendations 136 (e.g., or other media content recommendations) by stochastic analysis of the identifying criteria 132 associated with the viewer selected movies.

Stochastic analysis provides a technique to generalize conclusions from small sample sizes. In an embodiment, stochastic analysis provides a technique to generalize a movie recommendation 136 from a small sample of viewer selected movies (i.e., given movie selection choices 126). For example, the analytics module 120 initiates stochastic analysis to determine a movie recommendation 136 based on probability determined from numeric ratings of the identifying criteria 132 associated with the viewer selected movies. Stochastic analysis can also be described as a technique or approach to determining “x” based on probability, where a stochastic approach involves obtaining values from a sequence of distributed random variables.

As described herein, the analytics module 120 can implement stochastic analysis, such as a simplified version of the Deterministic Finite Element method which is an extension of the Weighted Integral Stochastic Finite Element Method. In practice, the probability of certain rare events can be predicated by forcing all of the variables to add to a constant. For media content such as movies, the variables are the attributes of the video content so the boundaries are already limited and the analysis predicts similarity. Based on the stochastic analysis, the movies can be organized into a linear array based on the relative percentage of the attributes for each movie.

In another embodiment, the recommendation system 118 for content distributor 102 can also receive viewer-selected preferences to weight the identifying criteria 132. For example, a viewer may provide numeric, weighted identifying criteria to weight a movie recommendation determination. The analytics module 120 can then incorporate and apply stochastic analysis on the weighted identifying criteria to determine a movie recommendation 136 for the viewer.

In another embodiment, the recommendation system 118 for content distributor 102 can compile descriptions of the identifying criteria 132 associated with the movies. For example, a plot of a movie may be further described as having a “happy ending”, “shocking ending”, “surprise ending”, and the like. The recommendation system 118 can generate qualitative metadata 138 of the movies from the compiled descriptions and a movie recommendation 136 can be further determined by applying the stochastic analysis on the qualitative metadata 138 associated with the viewer selected movies.

The qualitative metadata 138 associated with the media content (e.g., a movie or movies) can be any form of information that describes and/or characterizes the media content. For example, the qualitative metadata 138 can include a program or movie identifier, a title, a subject description of the program or movie, a plot description, actor information, a date of production, artistic information, music compilations, and any other possible descriptive information about the program or movie. Further, the qualitative metadata 138 can characterize a genre that describes the media content as being a movie, a comedy show, a sporting event, a news program, a sitcom, a talk show, an action/adventure program, or as any number of other descriptions.

Based on any one or combination of the identifying criteria associated with the viewer selected movies, a probability determined from numeric ratings of the identifying criteria, weighted identifying criteria, or other qualitative metadata associated with the viewer selected movies, the analytics module 120 can determine movie recommendations 136 by predicting other movies that the viewer may be interested in viewing based on just a few of the viewer selected movies.

After the movie recommendations are determined by stochastic analysis with the analytics module 120, the recommendation system 118 can then initiate that the movie recommendations 136 be communicated to the client device 104. Although the recommendation system 118 and the analytics module 120 are each illustrated and described as single applications (e.g., independent components of content distributor 102), each can be implemented as several component applications or modules distributed to perform one or more functions of recommendations from stochastic analysis. Alternatively, the recommendation system 118 and the analytics module 120 can be implemented together as a multi-functional component of content distributor 102 to implement embodiments of recommendations from stochastic analysis.

The example client device 104 can be implemented as any one or combination of a television set-top box, a digital video recorder (DVR) and playback system, an appliance device, a gaming console, a portable communication device, a portable computing device, and/or as any other type of television client device or computing-based device that may be implemented in a television entertainment and information system. Additionally, client device 104 can be implemented with any number and combination of differing components as further described with reference to the example device shown in FIG. 4. Client device 104 may also be associated with a user or viewer (i.e., a person) and/or an entity that operates the device such that a client device describes logical clients that include users, software, and/or devices.

In the example system 100, client device 104 includes one or more processors 140 (e.g., any of microprocessors, controllers, and the like), media content inputs 142, and media content 144 (e.g., received media content or media content that is being received). The media content inputs 142 can include any type of communication interfaces and/or data inputs, such as Internet Protocol (IP) inputs over which streams of television media content (e.g., IPTV media content) are received via the IP-based network 110 and/or the communication network 112.

The client device 104 is configured for communication with the content distributor(s) 102 via the IP-based and communication networks. A media content input 142 can receive media content 144 as an IPTV multicast from a content distributor 102. In addition, the media content inputs 142 can include any type of wireless, broadcast, and/or over-the-air inputs via which media content is received.

Client device 104 also includes a device manager 146 (e.g., a control application, software application, etc.) that can be implemented as computer-executable instructions and executed by the processor(s) 140 to implement embodiments of recommendations from stochastic analysis. In an embodiment, the device manager 146 can be implemented to initiate rendering the movie selection choices 126 on the user interface 130 when received from the content distributor 102. The device manager 146 can also be implemented to monitor and/or receive selectable inputs (e.g., user selections) via the input device 134, and communicate the viewer selections back to the content distributor 102.

The client device 104 can also include a search module 148 and a program guide application 150, both of which can be implemented as computer-executable instructions and executed by the processor(s) 140 to implement embodiments of recommendations from stochastic analysis. In an embodiment, the search module 148 can receive a viewer-initiated search request via the input device 134. The program guide application 150 can be implemented to process program guide data from which a program guide can be rendered and/or displayed for viewing on display device 106. A program guide may also be commonly referred to as an electronic program guide or an “EPG”. In this example, the user interface 130 may be rendered as a panel of a program guide search interface.

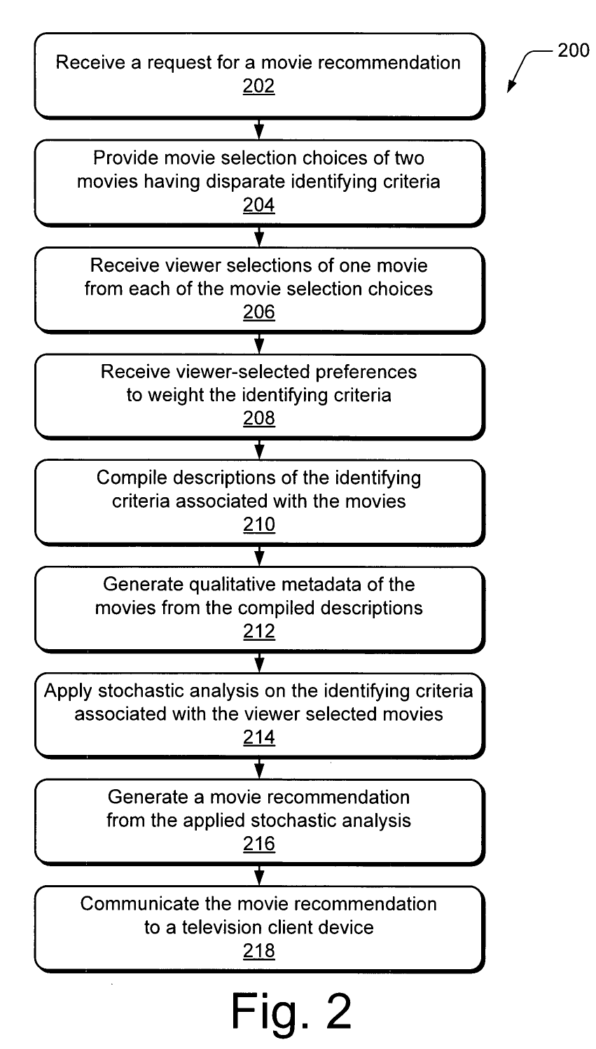

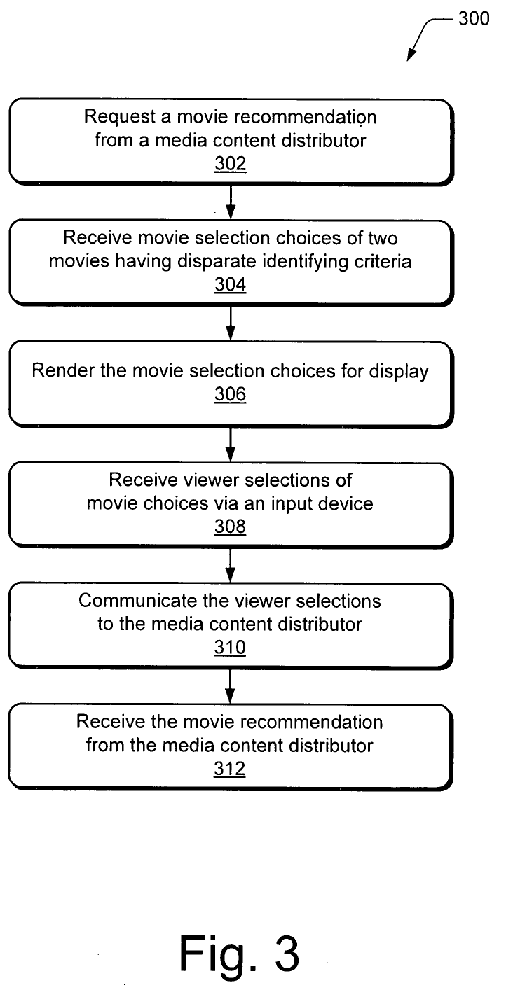

Generally, any of the functions, methods, procedures, and modules described herein can be implemented using hardware, software, firmware (e.g., fixed logic circuitry), manual processing, or any combination thereof. A software implementation of a function, method, procedure, or module represents program code that performs specified tasks when executed on a computing-based processor. Example methods 200 and 300 described with reference to respective FIGS. 2 and 3 may be described in the general context of computer-executable instructions. Generally, computer-executable instructions can include applications, routines, programs, objects, components, data structures, procedures, modules, functions, and the like that perform particular functions or implement abstract data types.

The method(s) may also be practiced in a distributed computing environment where functions are performed by remote processing devices that are linked through a communications network. In a distributed computing environment, computer-executable instructions may be located in both local and remote computer storage media, including memory storage devices. Further, the features described herein are platform-independent such that the techniques may be implemented on a variety of computing platforms having a variety of processors.

FIG. 2 illustrates example method(s) 200 of recommendations from stochastic analysis, and is described with reference to a media content distributor. The order in which the method is described is not intended to be construed as a limitation, and any number of the described method blocks can be combined in any order to implement the method, or an alternate method. At block 202, a request is received for a recommended movie.

For example, content distributor 102 (FIG. 1) receives a request 122 for movie recommendations (or other media content recommendations) from a client device 104 when initiated by a viewer via an input device 134.

At block 204, movie selection choices are provided where each choice includes two movies having disparate identifying criteria. For example, the content distributor 102 communicates several movie selection choices to a viewer via the television client device 104. A movie selection choice 126 of two different movies 128(A) and 128(B) can be received by the television client device 104 and displayed as a user interface 130 on the display device 106. The movie selection choices 126 include two different movies that have disparate identifying criteria 132 which can be any one of a category of a movie, an attribute of the movie, an aspect of the movie, and/or any other associated information. In an embodiment, the movie selection choices 126 are displayed to the to the viewer in an established sequence such that a movie recommendation is generated based on a sequence that the viewer selected movies are received.

At block 206, viewer selections of one movie from each of the movie selection choices are received. For example, a viewer can select whichever of the two different movies 128(A) and 128(B) that appeals to the viewer. A viewer can interact with the television client device 104 and initiate selections of the movie choices from the user interface 130 with user inputs on the input device 134. The recommendation system 118 for content distributor 102 receives the viewer selections of one movie from each of the movie selection choices 126.

At block 208, viewer-selected preferences to weight the identifying criteria are received. For example, the recommendation system 118 for content distributor 102 optionally receives viewer-selected preferences to weight the identifying criteria 132. For example, a viewer may provide numeric, weighted identifying criteria to weight a movie recommendation determination at the content distributor 102.

At block 210, descriptions of the identifying criteria associated with the movies are compiled, and at block 212, qualitative metadata of the movies is generated from the compiled descriptions. For example, the recommendation system 118 for content distributor 102 optionally compiles descriptions of the identifying criteria 132 associated with the movies, and can then generate qualitative metadata 138 of the movies from the compiled descriptions. The qualitative metadata 138 associated with the media content (e.g., a movie or movies) can be any form of information that describes and/or characterizes the media content.

At block 214, stochastic analysis is applied to the identifying criteria associated with the viewer selected movies from each of the movie selection choices. For example, the analytics module 120 for content distributor 102 generates one or more movie recommendations 136 (e.g., or other media content recommendations) by stochastic analysis of the identifying criteria 132 associated with the viewer selected movies. In an embodiment, the analytics module 120 determines movie recommendations 136 by stochastic analysis based on probability determined from numeric ratings of the identifying criteria 132 associated with the viewer selected movies. In another embodiment, the analytics module 120 determines movie recommendations 136 by stochastic analysis on the weighted identifying criteria received from a viewer (i.e., at block 208). In another embodiment, the analytics module 120 determines movie recommendations 136 by stochastic analysis on the qualitative metadata 138 associated with the viewer selected movies from each of the selection choices 126.

At block 216, a movie recommendation is generated from the applied stochastic analysis, and at block 218, the movie recommendation is communicated to the television client device. For example, after the movie recommendations are determined by stochastic analysis with the analytics module 120, the recommendation system 118 initiates that the movie recommendations 136 be communicated to the client device 104.

FIG. 3 illustrates example method(s) 300 of recommendations from stochastic analysis and is described with reference to a television client device. The order in which the method is described is not intended to be construed as a limitation, and any number of the described method blocks can be combined in any order to implement the method, or an alternate method.

At block 302, a movie recommendation is requested from a media content distributor. For example, a viewer at client device 104 (FIG. 1) can initiate a request for a movie recommendation with the input device 134 and the search module 148 for client device 104 receives the viewer-initiated search request.

At block 304, movie selection choices are received where each choice includes two movies having disparate identifying criteria. For example, the client device 104 receives several movie selection choices from the content distributor 102. In an embodiment, a movie selection choice 126 includes two different movies that have disparate identifying criteria 132 which can be any one of a category of a movie, an attribute of the movie, an aspect of the movie, and/or any other associated information.

At block 306, the movie selection choices are rendered for display. For example, the device manager 146 for client device 104 initiates rendering the movie selection choices 126 for display as user interface 130 on display device 106. At block 308, viewer selections of movie choices are received via an input device, and at block 310, the viewer selections are communicated to the media content distributor. For example, a viewer can select one of the two movies 128(A) and 128(B) of a movie selection choice 126 with input device 134. The device manager 146 for client device 104 receives the viewer-selectable inputs and initiates communicating the viewer selected movies back to the content distributor 102 that then applies stochastic analysis to determine the movie recommendations 136.

At block 312, the movie recommendation is received from the media content distributor. For example, client device 104 receives the movie recommendation 136 from content distributor 102 when the movie recommendation is determined by stochastic analysis of the viewer selected movies, and the movie recommendation is rendered for display on the user interface 130 for viewer selection.

FIG. 4 illustrates various components of an example device 400 that can be implemented as any form of a computing, electronic, appliance, television client device, or television system device to implement various embodiments of recommendations from stochastic analysis. For example, device 400 can be implemented as the television client device or content distributor as shown in FIG. 1. In various embodiments, device 400 can be implemented as any one or combination of a television client device, a digital video recorder (DVR), a gaining system or console, a computing-based device, an appliance device, and/or as any other type of similar device.

Device 400 includes one or more media content inputs 402 that may include Internet Protocol (IP) inputs over which streams of media content are received via an IP-based network. Device 400 further includes communication interface(s) 404 that can be implemented as any one or more of a serial and/or parallel interface, a wireless interface, any type of network interface, a modem, and as any other type of communication interface. A network interface provides a connection between device 400 and a communication network by which other electronic and computing devices can communicate data with device 400.

Similarly, a serial and/or parallel interface provides for data communication directly between device 400 and the other electronic or computing devices. A modem also facilitates communication with other electronic and computing devices via a conventional telephone line, a DSL connection, cable, and/or other type of connection. A wireless interface enables device 400 to receive control input commands 406 and other data from an input device, such as from remote control device 408, a portable computing-based device (such as a cellular phone), or from another infrared (IR), 802.11, Bluetooth, or similar RF input device.

Device 400 also includes one or more processors 410 (e.g., any of microprocessors, controllers, and the like) which process various computer-executable instructions to control the operation of device 400, to communicate with other electronic and computing devices, and to implement embodiments of recommendations from stochastic analysis. Device 400 can be implemented with computer-readable media 412, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), any type of a digital versatile disc (DVD), and the like.

Computer-readable media 412 provides data storage mechanisms to store media content 414, as well as device applications 416 and any other types of information and/or data related to operational aspects of device 400. For example, an operating system 418 can be maintained as a computer application with the computer-readable media 412 and executed on processor(s) 410. The device applications can include a device manager 420 when device 400 is implemented as a television client device. The device manager 420 is shown as a software module in this example to implement various embodiments of recommendations from stochastic analysis. An example of the device manager 420 is described with reference to device manager 146 for client device 104 as shown in FIG. 1.

When implemented as a television client device, the device 400 can also include a DVR system 422 with playback application 424, and recording media 426 to maintain recorded media content 428 that device 400 receives and/or records. The recorded media content 428 can include the media content 414 that is received from a content distributor and recorded. For example, the media content 428 can be recorded when received as a viewer-scheduled recording, or when the recording media 426 is implemented as a pause buffer that records the media content 428 as it is being received and rendered for viewing.

Further, device 400 may access or receive additional recorded media content that is maintained with a remote data store (not shown). Device 400 may also receive media content from a video-on-demand server, or media content that is maintained at a broadcast center or content distributor that distributes the media content to subscriber sites and client devices. The playback application 424 can be implemented as a media control application to control the playback of media content 414, the recorded media content 428, and/or any other audio, video, and/or image media content which can be rendered and/or displayed for viewing.

Device 400 also includes an audio and/or video output 430 that provides audio and/or video data to an audio rendering and/or display system 432. The audio rendering and/or display system 432 can include any devices that process, display, and/or otherwise render audio, video, and image data. Video signals and audio signals can be communicated from device 400 to a display device via an R-F (radio frequency) link, S-video link, composite video link, component video link, DVI (digital video interface), analog audio connection, or other similar communication link. Alternatively, the audio rendering and/or display system 432 can be implemented as integrated components of the example device 400.

FIG. 5 illustrates an example entertainment and information system 500 in which embodiments of recommendations from stochastic analysis can be implemented. System 500 facilitates the distribution of media content, program guide data, and/or advertising content to multiple viewers and viewing systems. System 500 includes a content distributor 502 and any number of client systems 504 each configured for communication via a communication network 506. Each of the client systems 504 can receive data streams of media content, program content, program guide data, advertising content, closed captions data, and the like from content server(s) of the content distributor 502 via the communication network 506.

The communication network 506 can be implemented as any one or combination of a wide area network (e.g., the Internet), a local area network (LAN), an intranet, an IP-based network, a broadcast network, a wireless network, a Digital Subscriber Line (DSL) network infrastructure, a point-to-point coupling infrastructure, or as any other media content distribution network. Additionally, communication network 506 can be implemented using any type of network topology and any network communication protocol, and can be represented or otherwise implemented as a combination of two or more networks. A digital network can include various hardwired and/or wireless links 508, such as routers, gateways, and so on to facilitate communication between content distributor 502 and the client systems 504.

System 500 includes a media server 510 that receives content from various content sources 512, such as media content from a content provider, program guide data from a program guide source, and advertising content from an advertisement provider. In an embodiment, the media server 510 represents an acquisition server that receives audio and video content from a provider, an EPG server that receives the program guide data from a program guide source, and/or an advertising management server that receives the advertising content from an advertisement provider.

The content sources, such as the content provider, program guide source, and the advertisement provider control distribution of the media content, the program guide data, and the advertising content to the media server 510 and/or to other servers of system 500. The media content, program guide data, and advertising content can be distributed via various transmission media 514, such as satellite transmission, radio frequency transmission, cable transmission, and/or via any number of other wired or wireless transmission media. In this example, media server 510 is shown as an independent component of system 500 that communicates the program content, program guide data, and advertising content to content distributor 502. In an alternate implementation, media server 510 can be implemented as a component of content distributor 502.

Content distributor 502 is representative of a headend service in a content distribution system, for example, that provides the media content, program guide data, and advertising content to multiple subscribers (e.g., the client systems 504). The content distributor 502 can be implemented as a satellite operator, a network television operator, a cable operator, and the like to control distribution of media content, program and advertising content, such as movies, television programs, commercials, music, and any other audio, video, and/or image content to the client systems 504.

Content distributor 502 includes various content distribution components 516 to facilitate media content processing and distribution, such as a subscriber manager, a device monitor, and one or more content servers. The subscriber manager manages subscriber data, and the device monitor monitors the client systems 504 (e.g., and the subscribers), and maintains monitored client state information.

Although the various managers, servers, and monitors of content distributor 502 (to include the media server 510 in one embodiment) are described as distributed, independent components of content distributor 502, any one or more of the managers, servers, and monitors can be implemented together as a multi-functional component of content distributor 502. Additionally, any one or more of the managers, servers, and monitors described with reference to system 500 can implement features and embodiments of recommendations from stochastic analysis.

In this example, the content distributor 502 includes communication components 518 that can be implemented to facilitate media content distribution to the client systems 504 via the communication network 506. The content distributor 502 also includes one or more processors 520 (e.g., any of microprocessors, controllers, and the like) which process various computer-executable instructions to control the operation of content distributor 502. The content distributor 502 can be implemented with computer-readable media 522 which provides data storage to maintain software applications such as an operating system 524, an asset manager 526, a recommendation system 528, and an analytics module 530. The recommendation system 528 and the analytics module 530 can implement one or more embodiments of recommendations from stochastic analysis as described with reference to recommendation system 118 and analytics module 120 for content distributor 102 shown in FIG. 1.

The client systems 504 can each be implemented to include a client device 532 and a display device 534 (e.g., a television, LCD, and the like). A client device 532 of a respective client system 504 can be implemented in any number of embodiments, such as a set-top box, a digital video recorder (DVR) and playback system, an appliance device, a gaining system, and as any other type of client device that may be implemented in an entertainment and information system. In an alternate embodiment, a client system 504 may implemented with a computing device 536 as well as a client device. Additionally, any of the client devices 532 of a client system 504 can implement features and embodiments of recommendations from stochastic analysis as described herein.

Although embodiments of recommendations from stochastic analysis have been described in language specific to features and/or methods, it is to be understood that the subject of the appended claims is not necessarily limited to the specific features or methods described. Rather, the specific features and methods are disclosed as example implementations of recommendations from stochastic analysis.

1. A method, comprising:
receiving a request for a recommended movie;
providing a plurality of movie selection choices where each choice includes two movies having disparate identifying criteria;
receiving viewer selections of one movie from each of the movie selection choices; and
generating a movie recommendation by applying stochastic analysis on the identifying criteria associated with the viewer selected movies from each of the movie selection choices.

2. A method as recited in claim 1, further comprising communicating the movie recommendation to a television client device from which the request for the recommended movie was received.

3. A method as recited in claim 1, wherein the stochastic analysis determines the movie recommendation based on probability determined from numeric ratings of the identifying criteria associated with the viewer selected movies.

4. A method as recited in claim 1, wherein the identifying criteria associated with the viewer selected movies includes at least one of a category of a movie, an attribute of the movie, or an aspect of the movie.

5. A method as recited in claim 1, further comprising receiving viewer-selected preferences to weight the identifying criteria, and wherein the movie recommendation is further generated by applying the stochastic analysis on the weighted identifying criteria.

6. A method as recited in claim 1, wherein the plurality of movie selection choices are provided to the viewer in an established sequence, and wherein the movie recommendation is further generated based on a sequence that the viewer selected movies are received.

7. A method as recited in claim 1, further comprising:
compiling descriptions of the identifying criteria associated with the movies; and
generating qualitative metadata of the movies from the compiled descriptions.

8. A method as recited in claim 7, wherein the movie recommendation is further generated by applying the stochastic analysis on the qualitative metadata associated with the viewer selected movies from each of the movie selection choices.

9. A media content distributor, comprising:
a recommendation system configured to:
receive a request for recommended media content from a television client device;
provide a plurality of content selection choices to a viewer via the television client device, where each content selection choice includes media content having disparate identifying criteria;
receive selections of media content from each of the content selection choices; and
an analytics module configured to generate the recommended media content by stochastic analysis of the identifying criteria associated with the selections of media content.

10. A media content distributor as recited in claim 9, wherein the recommendation system is further configured to initiate that the recommended media content be communicated to the television client device.

11. A media content distributor as recited in claim 9, wherein the analytics module is further configured to apply the stochastic analysis to generate the recommended media content based on probability determined from numeric ratings of the identifying criteria associated with the selections of media content.

12. A media content distributor as recited in claim 9, wherein the identifying criteria associated with the selections of media content includes at least one of a category of the media content, an attribute of the media content, or an aspect of the media content.

13. A media content distributor as recited in claim 9, wherein the recommendation system is further configured to receive viewer-selected preferences to weight the identifying criteria, and wherein the analytics module is further configured to apply the stochastic analysis to generate the recommended media content based on the weighted identifying criteria.

14. A media content distributor as recited in claim 9, wherein the recommendation system is further configured to provide the plurality of content selection choices in an established sequence, and wherein the analytics module is further configured to generate the recommended media content based on a sequence that the selections of media content are received.

15. A media content distributor as recited in claim 9, wherein the recommendation system is further configured to:
compile descriptions of the identifying criteria associated with the media content; and
generate qualitative metadata of the media content from the compiled descriptions.

16. A media content distributor as recited in claim 15, wherein the analytics module is further configured to apply the stochastic analysis to generate the recommended media content based on the qualitative metadata associated with the selections of media content.

17. One or more computer-readable media comprising computer-executable instructions that, when executed, direct a media content distributor to:
compile descriptions of identifying criteria associated with movies;
generate qualitative metadata of the movies from the compiled descriptions;
receive viewer selections of one movie from each of a plurality of movie selection choices where each choice includes two of the movies having disparate qualitative metadata; and
apply stochastic analysis on the qualitative metadata associated with the viewer selected movies from each of the movie selection choices to generate a movie recommendation.

18. One or more computer-readable media as recited in claim 17, further comprising computer-executable instructions that, when executed, direct the media content distributor to communicate the movie recommendation to a television client device from which the viewer selected movies are received.

19. One or more computer-readable media as recited in claim 17, further comprising computer-executable instructions that, when executed, direct the media content distributor determine the movie recommendation based on probability determined from numeric ratings of the qualitative metadata associated with the viewer selected movies.

20. One or more computer-readable media as recited in claim 17, further comprising computer-executable instructions that, when executed, direct the media content distributor to compile the descriptions of the identifying criteria which includes at least one of a category of a movie, an attribute of the movie, or an aspect of the movie.
